(19) United States
(12) Patent Application Publication
(10) Pub. No.: US 2007/0217333 A1
(43) Pub. Date: Sep. 20, 2007

(54) Apparatus and method for processing reception frame in a wireless terminal

(75) Inventors: Chang-Woo Seo, Suwon-si (KR); Ki-Ho Kim, Seoul (KR); Jae-Kon Lee, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/714,054

(22) Filed: Mar. 5, 2007

(30) Foreign Application Priority Data
Mar. 4, 2006 (KR) 20735/2006

(51) Int. Cl. H04L 12/26; H04L 12/56

(52) U.S. Cl. 370/229; 370/412

(57) ABSTRACT

Disclosed is an apparatus and a method for estimating a state of a reception buffer, and processing a downlink frame based on the estimated state of the reception buffer in a wireless terminal. The method includes continuously monitoring a level of a reception buffer; determining based on the level of the reception buffer whether to store the incoming data frame; discarding the incoming data frame when the level of the reception buffer is insufficient for storage of the incoming data frame; and reporting to a transmitter that the incoming data frame has been discarded.

### PRIORITY

This application claims priority under 35 U.S.C. §119(a) to an application filed in the Korean Industrial Property Office on Mar. 4, 2006 and assigned Serial No. 2006-20735, the contents of which are hereby incorporated by reference.

### BACKGROUND OF THE INVENTION

1. Field of the Invention

The present invention relates to an apparatus and a method for processing a reception frame in a reception apparatus of a wireless network, and more particularly to an apparatus and a method for processing a reception frame based on a state of a reception buffer.

2. Description of the Related Art

Usually, a wireless terminal transmits/receives data to/from a base station using wireless resources. A data frame transmitted from a wireless terminal to a base station is called an uplink frame, and a data frame transmitted from a base station to a wireless terminal is called a downlink frame.

In a wireless network, the base station does not require mobility and thus there is no limitation in the power and performance of the base station. However, mobility is an important factor that must be necessarily considered for the wireless terminal. Therefore, for a wireless terminal, there have been various attempts to provide a scheme for more efficiently using the limited power to increase the time of using the wireless terminal.

Further, it is impossible to indefinitely add hardware in order to improve the performance of a wireless terminal. Therefore, there has been a request for a scheme for more efficiently utilizing the limited performance of a wireless terminal.

For example, a reception buffer has a limited storage capacity, and thus has a limitation in the quantity of downlink data which the reception buffer can store. If a downlink frame is received in a state in which overflow has occurred in the reception buffer, the terminal cannot process the downlink frame. When this situation occurs, an existing wireless terminal transmits a response message in response to the failure in the processing of the downlink frame to a base station. The base station recognizes from the response message that the wireless terminal failed to normally receive the downlink frame, and retransmits the downlink frame.

The downlink frame retransmitted from the base station as described above may increase the load on the reception buffer of the wireless terminal. Further, in the worst case, the overload on the reception buffer may negatively influence the data that have been normally stored already.

Therefore, it is necessary to arrange a scheme for preventing the occurrence of additional load in a reception buffer of a wireless terminal due to overflow occurring in the reception buffer.

### SUMMARY OF THE INVENTION

Accordingly, the present invention has been made to solve the above-mentioned problems occurring in the prior art, and the present invention provides an apparatus and a method for estimating a state of a reception buffer, and processing a downlink frame based on the estimated state of the reception buffer in a wireless terminal.

Also, the present invention provides an apparatus and a method for estimating a level at which a reception buffer is used and forcibly discarding a received downlink frame in a wireless terminal.

Also, the present invention provides an apparatus and a method for transmitting an intended response message in response to a downlink frame forcibly discarded due to the limitation of the reception buffer in a wireless terminal.

In accordance with an aspect of the present invention, there is provided a method for processing an incoming data frame in a wireless network, comprising continuously monitoring a level of a reception buffer; determining based on the level of the reception buffer whether to store the incoming data frame; discarding the incoming data frame when the level of the reception buffer is insufficient for storage of the incoming data frame; and reporting to a transmitter that the incoming data frame has been discarded.

Preferably, the determining step comprises enabling a reception buffer control function when a predetermined downlink MAP duration interval does not satisfy a capacity of the reception buffer; when the reception buffer control function has been enabled, determining if the level of the reception buffer can allow a length of the incoming data frame; determining if a processing speed of data stored in the reception buffer satisfies a data rate of the incoming data frame; and determining that it is impossible to store the incoming data frame in the reception buffer, when the level of the reception buffer cannot allow the length of the incoming data frame and the processing speed of the data stored in the reception buffer cannot satisfy the data rate of the incoming data frame.

More preferably, when the incoming data frame is a voice frame, the incoming data frame is stored in the reception buffer regardless of the length of the incoming data frame.

In accordance with another aspect of the present invention, there is provided an apparatus for processing an incoming data frame in a wireless network, comprising a reception buffer for storing or discarding the incoming data frame according to a control signal; a transmission buffer for outputting a response message in response to the incoming data frame according to a control signal; a buffer controller for continuously monitoring a level of a reception buffer, determining based on the level of the reception buffer whether to store the incoming data frame, discarding the incoming data frame when the level of the reception buffer is insufficient for storage of the incoming data frame, and outputting a control signal that commands reporting to a transmitter that the incoming data frame has been discarded.

Preferably, the buffer controller enables a reception buffer control function when predetermined downlink MAP duration interval does not satisfy a capacity of the reception buffer; when the reception buffer control function has been enabled, the buffer controller determines if the level of the reception buffer can allow a length of the incoming data frame; determines if a processing speed of data stored in the reception buffer satisfies a data rate of the incoming data frame; and determines that it is impossible to store the incoming data frame in the reception buffer, when the level of the reception buffer cannot allow the length of the incoming data frame and the processing speed of the data stored in the reception buffer cannot satisfy the data rate of the incoming data frame.

More preferably, when the incoming data frame is a voice frame, the buffer controller stores the incoming data frame in the reception buffer regardless of the length of the incoming data frame.

### BRIEF DESCRIPTION OF THE DRAWINGS

The above and other aspects, features and advantages of the present invention will be more apparent from the following detailed description taken in conjunction with the accompanying drawings, in which:

FIG. 1 is a block diagram illustrating the concept of state transition for processing of uplink data through a buffer control function according to an embodiment of the present invention;

FIG. 2 illustrates an example of an operation based on a time division scheme according to an embodiment of the present invention;

FIG. 3 is a block diagram illustrating a structure of a wireless terminal for processing an uplink data frame according to an embodiment of the present invention; and

FIG. 4 is a flow diagram illustrating a method for processing an uplink frame according to an embodiment of the present invention.

### DETAILED DESCRIPTION OF THE EXEMPLARY EMBODIMENT

Hereinafter, exemplary embodiments of the present invention will be described with reference to the accompanying drawings. In the following description, a detailed description of known functions and configurations incorporated herein will be omitted when it may make the subject matter of the present invention rather unclear. Further, various specific definitions found in the following description are provided only to help general understanding of the present invention, and it is apparent to those skilled in the art that the present invention can be implemented without such definitions.

While the following description of the present invention discusses only the downlink, it is noted that this is only an example of an application of the present invention to a reception buffer of a wireless terminal. However, it will be obvious to one skilled in the art that the present invention can be also applied to the uplink, that is, the base station.

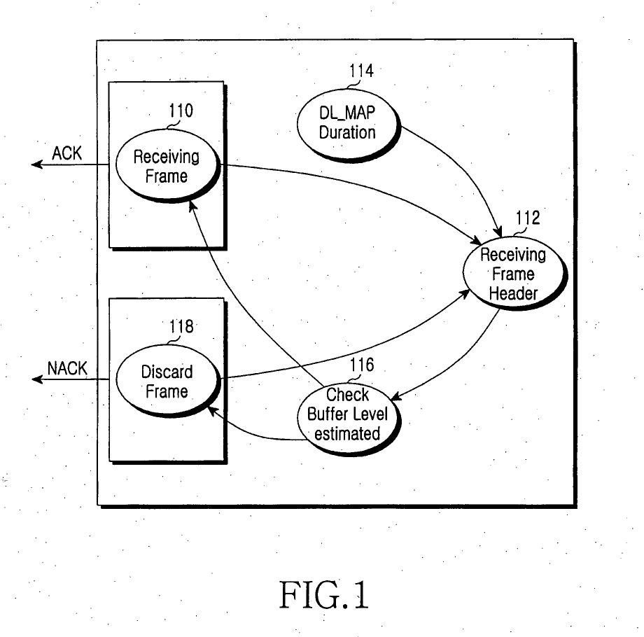

FIG. 1 is a block diagram illustrating the concept of state transition for processing of uplink data through a buffer control function according to an embodiment of the present invention.

Referring to FIG. 1, a wireless terminal receives a data frame 110. Upon receiving the data frame, the wireless terminal identifies predetermined downlink MAP duration information 114. The wireless terminal identifies the frame length, data rate, etc. from the header information of the incoming data frame 112. Further, the wireless terminal examines a buffer level by identifying a current state of a reception buffer 116. The wireless terminal determines based on the identified information if it will store the incoming data frame in the reception buffer or discard the incoming data frame 118.

Based on a result of the above determination, the wireless terminal transmits an ACK message or a NACK message to the base station.

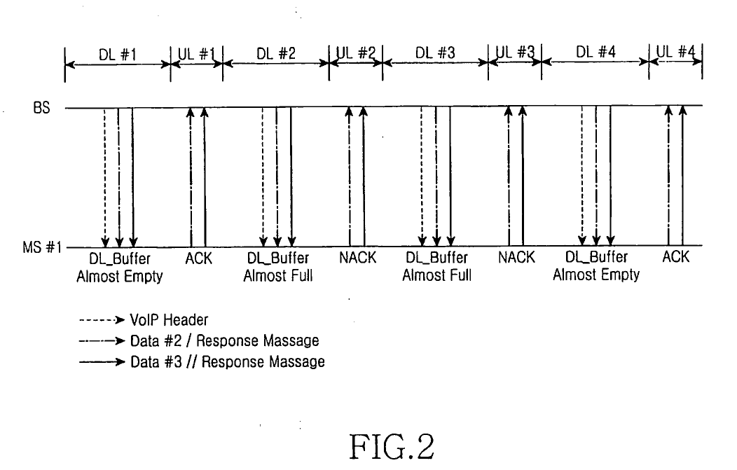

FIG. 2 illustrates an example of an operation based on a time division scheme according to an embodiment of the present invention.

Referring to FIG. 2, the base station transmits a data frame in a downlink transmission duration. The wireless terminal continuously monitors the level of the reception buffer, in processing the downlink frame in the downlink transmission duration. The monitoring of the level of the reception buffer is performed by a MAC layer. If the level of the reception buffer corresponds to a state in which the reception buffer has reached its capacity and cannot store data any more, the MAC layer processes the reception data frame through the buffer control function. According to the buffer control function, the MAC layer discards the incoming data frame when the buffer level can not accommodate the size of the incoming data frame. However, when the speed at which the data stored in the reception buffer is processed satisfies the data rate of the incoming data frame, the MAC layer stores the incoming data frame in the reception buffer.

Referring to FIG. 2, the first downlink transmission duration DL #1 corresponds to the case in which the transmitted data frame has been normally received by the wireless terminal. This implies that the reception buffer of the wireless terminal has a sufficient capacity for storage of the data frame (DL_Buffer Almost Empty). In this case, the wireless terminal transmits an ACK message to the base station at UL #1. However, the second downlink transmission duration DL #2 corresponds to the case in which the transmitted data frame cannot be normally received by the wireless terminal. This implies that the reception buffer of the wireless terminal has an insufficient capacity for storage of the data frame (DL_Buffer Almost Full).

Then, the wireless terminal processes the incoming data frame using a buffer control function. When a corresponding data frame has been discarded by the buffer control function, the wireless terminal transmits a NACK message to the base station in an uplink transmission duration at UL #2.

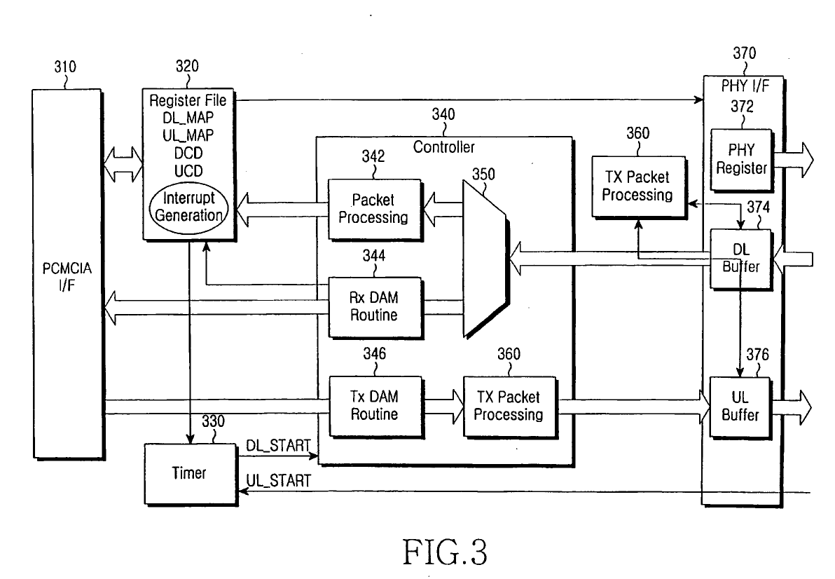

FIG. 3 is a block diagram illustrating a structure of a wireless terminal for processing an uplink data frame according to an embodiment of the present invention.

Referring to FIG. 3, the wireless terminal includes a buffer controller for controlling 340 a reception buffer in addition to the elements of a conventional wireless terminal, including PCM CIA I/F 310, register 320, timer 330, transmission packet processor 360, and PHY I/F 370 which includes PHY register 372, DL Buffer 374, and UL Buffer 376. The buffer controller includes packet processor 342, reception DAM routine 344, transmission processor 360, and multiplexer 350 continuously monitors the state of the reception buffer, and determines the level of the reception buffer based on a result of the monitoring. Further, if the buffer controller determines that the level of the reception buffer is insufficient for storage of the incoming data frame, the buffer controller performs the buffer control function in order to control the buffer. By performing the buffer control function, the buffer controller determines if the current level of the reception buffer can satisfy the size of the incoming data frame. When the current level of the reception buffer is insufficient for storage of the data frame and the incoming data frame is a voice frame, the data frame is stored. In contrast, when the data rate of the data frame is higher than the processing speed of the reception buffer, the data frame is discarded.

Meanwhile, under the control of the buffer controller, the reception buffer stores or discards the incoming data frame. Further, under the control of the buffer controller, a transmission buffer outputs a response message.

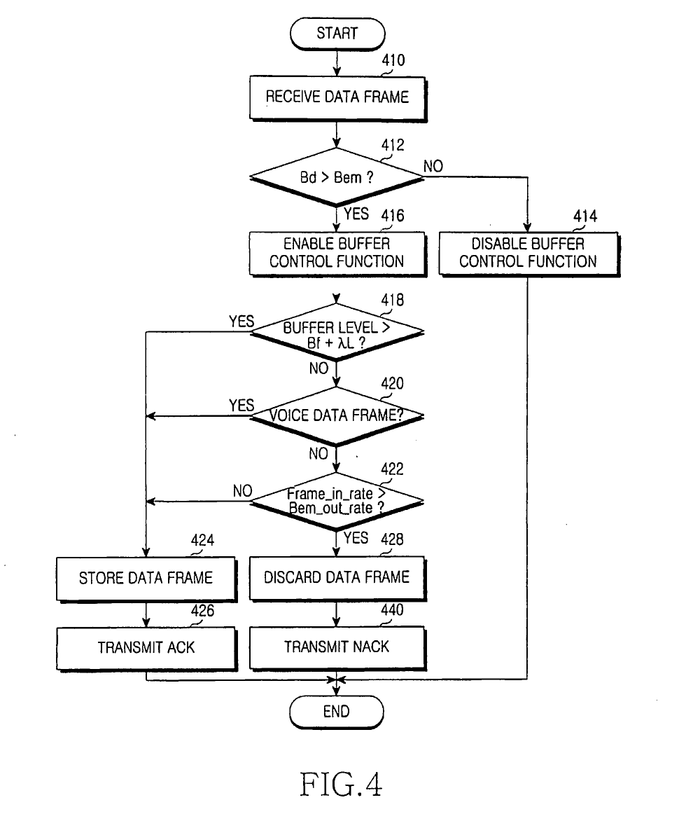

FIG. 4 is a flow diagram illustrating a method for processing an uplink frame according to an embodiment of the present invention.

Referring to FIG. 4, a wireless terminal receives a data frame from a base station in step 410. In step 412, the wireless terminal determines whether to perform a buffer control function. The determination in step 412 is performed through comparison between the downlink MAP duration information (DL-MAP duration information; hereinafter referred to as “Bd”) and the capacity (Bem) of the reception buffer. For example, when the downlink MAP duration information exceeds the capacity of the reception buffer (Bd>Bem), the wireless terminal determines that it is necessary to perform the buffer control function. However, when the downlink MAP duration information does not exceed the capacity of the reception buffer (Bd<Bem), the wireless terminal determines that it is unnecessary to perform the buffer control function.

When the wireless terminal determines that the buffer control function is necessary, the wireless terminal enables the buffer control function in step 416. However, when the wireless terminal determines that the buffer control function is unnecessary, the wireless terminal disables the buffer control function in step 414.

After enabling the buffer control function, the wireless terminal determines if the buffer level satisfies the length of the reception frame (that is, determines if Buffer_level>Bf+λL), where Bf is the length of a frame and, λL is beyond an error since the size of the buffer can not be estimated exactly. When the wireless terminal determines that the buffer level is enough to store the incoming data frame, the wireless terminal stores the incoming data frame in step 424. However, when the buffer level is not enough to store the incoming data frame, the wireless terminal determines in step 420 if the incoming data frame is a voice data frame. When the incoming data frame is a voice frame, the wireless terminal proceeds to step 424 in which the wireless terminal stores the incoming data frame. Then, in step 426, the wireless terminal transmits an ACK message to the base station.

However, when the incoming data frame is not a voice frame, the wireless terminal determines in step 422 if it will store the incoming data frame, through comparison between the data rate of the data frame and the processing speed of the data stored in the reception buffer. When the data rate of the data frame satisfies the processing speed of the data stored in the reception buffer, the wireless terminal stores the incoming data frame in the reception buffer in step 424. When the incoming data frame has been stored in the reception buffer, the wireless terminal transmits an ACK message to the base station in step 426. In step 422, when the data rate of the data frame does not satisfy the processing speed of the data stored in the reception buffer, the wireless terminal discards the data frame in step 428 and transmits a NACK message to the base station in step 440.

According to the present invention as described above, a wireless terminal performs a buffer control function when downlink MAP duration information exceeds a capacity of a reception buffer. When the buffer control function is performed, the wireless terminal discards the voice data frame having a size exceeding the buffer level.

When the data rate of the data frame satisfies the processing speed of the data stored in the reception buffer, the wireless terminal stores the incoming data frame in the reception buffer. In the case where the wireless terminal discards the voice data frame having a size exceeding the buffer level, the voice data frame is not stored and is discarded.

Further, the wireless terminal discards the data frame, when the data rate of the data frame exceeding the buffer level exceeds the processing speed of the reception buffer.

According to the present invention as described above, it is possible to monitor the state of a reception buffer and determine based on a result of the monitoring whether to store an incoming data frame. As a result, it is possible to prevent occurrence of data loss due to overload of the reception buffer. That is, the present invention not only can prevent occurrence of overflow in the reception buffer but can also prevent loss of the entire frame. Further, the present invention can reduce the rate of retransmission of the data frame and reduce the average quantity of consumed power, thereby maximizing the performance of the terminal.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A method for processing an incoming data frame in a wireless network, the method comprising the steps of:
(1) continuously monitoring a level of a reception buffer;
(2) determining based on the level of the reception buffer whether to store the incoming data frame;
(3) discarding the incoming data frame when the level of the reception buffer is insufficient for storage of the incoming data frame; and
(4) reporting to a transmitter that the incoming data frame has been discarded.

2. The method as claimed in claim 1, wherein step (2) comprises:
enabling a reception buffer control function when a predetermined downlink MAP duration interval does not satisfy a capacity of the reception buffer;
when the reception buffer control function has been enabled, determining if the level of the reception buffer can allow a length of the incoming data frame;
determining if a processing speed of data stored in the reception buffer satisfies a data rate of the incoming data frame; and
determining that it is impossible to store the incoming data frame in the reception buffer, when the level of the reception buffer cannot allow the length of the incoming data frame and the processing speed of the data stored in the reception buffer cannot satisfy the data rate of the incoming data frame.

3. The method as claimed in claim 2, wherein, when the incoming data frame is a voice frame, the incoming data frame is stored in the reception buffer regardless of the length of the incoming data frame.

4. An apparatus for processing an incoming data frame in a wireless network, the apparatus comprising:
a reception buffer for storing or discarding the incoming data frame according to a control signal;
a transmission buffer for outputting a response message in response to the incoming data frame according to a control signal;
a buffer controller for continuously monitoring a level of a reception buffer, determining based on the level of the reception buffer whether to store the incoming data frame, discarding the incoming data frame when the level of the reception buffer is insufficient for storage of the incoming data frame, and outputting a control signal that commands reporting to a transmitter that the incoming data frame has been discarded.

5. The apparatus as claimed in claim 4, wherein the buffer controller:
enables a reception buffer control function when a predetermined downlink MAP duration interval does not satisfy a capacity of the reception buffer;
determines if the level of the reception buffer can allow a length of the incoming data frame, when the reception buffer control function has been enabled;
determines if a processing speed of data stored in the reception buffer satisfies a data rate of the incoming data frame; and
determines that it is impossible to store the incoming data frame in the reception buffer, when the level of the reception buffer cannot allow the length of the incoming data frame and the processing speed of the data stored in the reception buffer cannot satisfy the data rate of the incoming data frame.

6. The apparatus as claimed in claim 5, wherein, when the incoming data frame is a voice frame, the buffer controller stores the incoming data frame
in the reception buffer regardless of the length of the incoming data frame.
